(19) United States
(12) Patent Application Publication
(10) Pub. No.: US 2026/0009749 A1
(43) Pub. Date: Jan. 8, 2026

(54) X-RAY MEASUREMENT SYSTEM AND X-RAY MEASUREMENT METHOD

(71) Applicant: NanoSeex Inc., Hsinchu County (TW)

(72) Inventors: YU-YAN AU YONG, Hsinchu County (TW); PO-TSANG WU, Hsinchu County (TW); CHUN-TING LIU, Hsinchu County (TW); PO-CHING HE, Hsinchu County (TW); TSUNG-HSIEN HAN, Hsinchu County (TW)

(21) Appl. No.: 19/329,581

(22) Filed: Sep. 16, 2025

Related U.S. Application Data
(63) Continuation-in-part of application No. 18/991,662, filed on Dec. 22, 2024.

(30) Foreign Application Priority Data
Apr. 23, 2024 (TW) 113115006
May 15, 2025 (TW) 114118190

(51) Int. Cl. G01N 23/18; G01N 21/88; G01N 21/95

(52) U.S. Cl. CPC G01N 23/18; G01N 21/8806; G01N 21/9501; G01N 2223/6116

(57) ABSTRACT

An X-ray measurement system and an X-ray measurement method. An X-ray source is configured to generate an incident X-ray beam. An optical mirror assembly is configured to focus the incident X-ray beam at a predetermined position. A divergence angle control element is disposed between the optical mirror assembly and the predetermined position. The divergence angle control element has a first portion and a second portion that are spaced apart from each other by a predetermined distance. At least a portion of the focused incident X-ray beam passes between the first portion and the second portion. A two-dimensional detector is configured to receive a measurement X-ray beam generated from a test object that is irradiated by the focused incident X-ray beam, and the measurement X-ray beam has a divergence angle that varies with the predetermined distance.

### CROSS-REFERENCE TO RELATED PATENT APPLICATION

This application claims the benefit of priorities to Taiwan Patent Applications No. 113115006, filed on Apr. 23, 2024, and No. 114118190, filed on May 15, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system and a method, and more particularly to an X-ray measurement system and an X-ray measurement method.

### BACKGROUND OF THE DISCLOSURE

Conventional semiconductor structures (e.g., gate-all-around (GAA) and fin field-effect transistors (FinFET), etc.) have complex three-dimensional architectures that require high-precision inspection techniques to ensure process stability and device reliability.

In X-ray inspection, although one-dimensional sensors have high resolution and linear detection accuracy, they can only obtain image data along a single direction. Therefore, they must gradually acquire multiple linear data through mechanical scanning of the sample or radiation source to reconstruct a complete image. This scanning method not only increases system complexity, but also imposes stringent requirements on positioning accuracy and mechanical stability. More importantly, since the sensor itself can only output a single row of data at a time, the sensor cannot simultaneously acquire full-area information, thereby limiting the effectiveness of the sensor in real-time inspection or high-speed production line applications.

### SUMMARY OF THE DISCLOSURE

In response to the above-referenced technical inadequacy, the present disclosure provides an X-ray measurement system and an X-ray measurement method.

In order to solve the above-mentioned problems, one of the technical aspects adopted by the present disclosure is to provide an X-ray measurement system. The X-ray measurement system includes an X-ray source, an optical mirror assembly, a divergence angle control element, and a two-dimensional detector. The X-ray source is configured to generate an incident X-ray beam. The optical mirror assembly is configured to focus the incident X-ray beam at a predetermined position. The divergence angle control element is disposed between the optical mirror assembly and the predetermined position, and the divergence angle control element has a first portion and a second portion that are spaced apart from each other by a predetermined distance. At least a portion of focused incident X-ray beam passes between the first portion and the second portion. The two-dimensional detector is configured to receive a measurement X-ray beam generated from a test object that is irradiated by the focused incident X-ray beam, and the measurement X-ray beam has a divergence angle that varies with the predetermined distance.

In order to solve the above-mentioned problems, another one of the technical aspects adopted by the present disclosure is to provide an X-ray measurement method, and the X-ray measurement method includes following processes: configuring an X-ray source to generate an incident X-ray beam; focusing the incident X-ray beam at a predetermined position through an optical mirror assembly; disposing a test object on the predetermined position; and configuring a two-dimensional detector to receive a measurement X-ray beam generated from the test object that is irradiated by the focused incident X-ray beam through a divergence angle control element. The divergence angle control element is disposed between the optical mirror assembly and the predetermined position, and the divergence angle control element has a first portion and a second portion that are spaced apart from each other by a predetermined distance. At least a portion of the focused incident X-ray beam passes between the first portion and the second portion, and the measurement X-ray beam has a divergence angle that varies with the predetermined distance.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of an X-ray measurement system according to one embodiment of the present disclosure;

FIG. 2 is a schematic view of the X-ray measurement system according to one embodiment of the present disclosure;

FIG. 3 is a schematic view of a divergence angle control element according to one embodiment of the present disclosure;

FIG. 4 is a schematic exploded view of a two-dimensional detector according to one embodiment of the present disclosure;

FIG. 5 is a schematic architectural view of another two-dimensional detector according to one embodiment of the present disclosure;

FIG. 6 is a curve diagram of a divergence angle and a predetermined distance according to one embodiment of the present disclosure;

FIG. 7 is a flowchart of an X-ray measurement method according to one embodiment of the present disclosure;

FIG. 8 is actual measurement results and a simulation curve diagram of the X-ray measurement system according to one embodiment of the present disclosure;

FIG. 9 is another actual measurement results and the simulation curve diagram of the X-ray measurement system according to one embodiment of the present disclosure; and

FIG. 10 is another actual measurement results and the simulation curve diagram of the X-ray measurement system according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

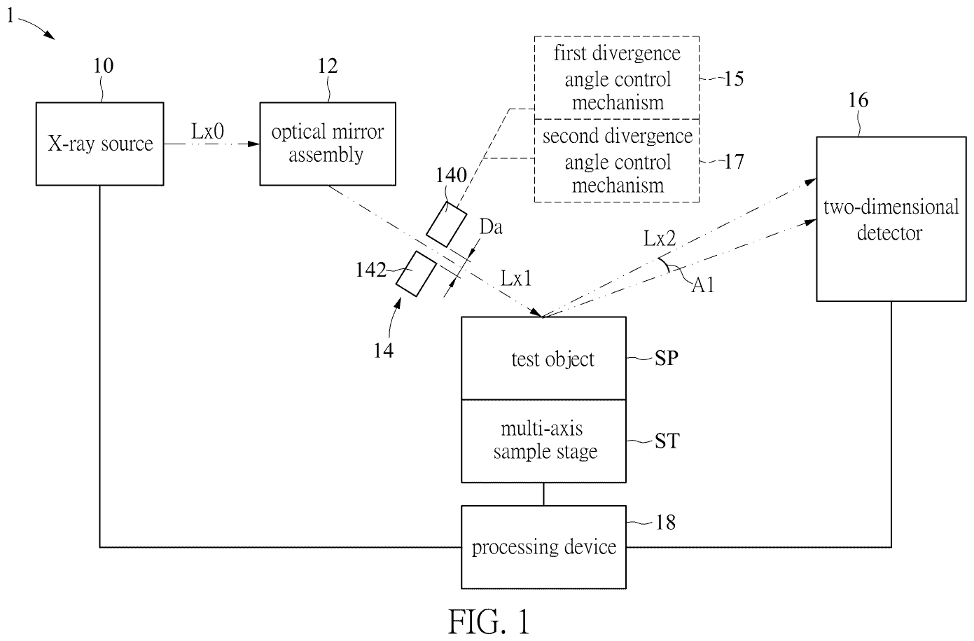

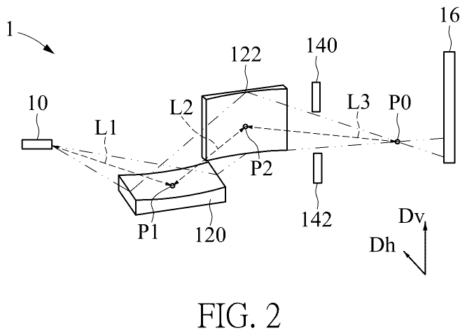

FIG. 1 is a functional block diagram of an X-ray measurement system according to one embodiment of the present disclosure, and FIG. 2 is a schematic view of the X-ray measurement system according to one embodiment of the present disclosure. Referring to FIG. 1 to FIG. 4, an embodiment of the present disclosure provides an X-ray measurement system 1. The X-ray measurement system 1 includes an X-ray source 10, an optical mirror assembly 12, a divergence angle control element 14, and a two-dimensional detector 16. The X-ray measurement system 1 further includes a multi-axis sample stage ST for carrying a test object SP, which is a multi-axis movable stage (e.g., a three-axis tilt platform or a gimbal-type tilt platform). The multi-axis sample stage ST can have a stage moving mechanism and a stage rotating mechanism. The stage moving mechanism can, for example, include stepper motors corresponding to three axes for moving the test object SP along one or more of the X, Y, and Z axes. By controlling the stepper motor of each axis, the test object SP can be precisely moved to different positions. Taking the gimbal-type tilt platform as an example, the stage rotating mechanism can, for example, be a gimbal joint connected to the platform portion, enabling the test object SP to rotate about one or more of the X, Y, and Z axes. More specifically, rotation means of the multi-axis sample stage ST may include control of the azimuthal rotation around the Y-axis and the azimuthal rotation around the Z-axis, thereby enabling full-range scanning of the test object SP.

The X-ray measurement system 1 further includes a processing device 18. The processing device 18 can, for example, be a computer system including a processor and a memory, and the processing device 18 is configured to execute stored instruction sets or program code to control the multi-axis sample stage ST and controllable components in the X-ray measurement system 1.

The X-ray source 10 is configured to generate an incident X-ray beam Lx0. The X-ray source 10 can include an X-ray tube. An electron beam emitter and a target are disposed in the X-ray tube. The target is bombarded by an accelerated electron beam to generate the incident X-ray beam Lx0. In addition, by selecting different target materials (e.g., copper (Cu), iron (Fe), molybdenum (Mo), etc.), the incident X-ray beams Lx0 with different energies or wavelengths (or frequencies) can be produced.

The optical mirror assembly 12 is configured to focus the incident X-ray beam Lx0 at a predetermined position P0. The optical mirror assembly 12 includes a first focusing lens 120 and a second focusing lens 122. The first focusing lens 120 and the second focusing lens 122 are respectively configured to focus the incident X-ray beam Lx0 in a horizontal direction Dh and a vertical direction Dv, and the horizontal direction Dh is perpendicular to the vertical direction Dv. The optical mirror assembly 12 can, for example, be a Kirkpatrick-Baez (KB) mirror assembly. The optical mirror assembly 12 is a set of bidirectional focusing optical components and is disposed at a fixed position downstream of the X-ray source 10. A purpose of the optical mirror assembly 12 is to use reflection and mirror curvature to simultaneously focus the incident X-ray beam Lx0 in the horizontal direction Dh and the vertical direction Dv to produce a high-brightness, small-sized focal spot that supports high-resolution detection and imaging applications. The first focusing lens 120 and the second focusing lens 122 can be set at specific incidence angles (typically from several mrad to several tens of mrad) to achieve optimal reflection efficiency. The incidence angle and radius of mirror curvature of the first focusing lens 120 together determine a relationship between an object distance (i.e., the distance from the X-ray source 10 to a mirror surface of the first focusing lens 120) and an image distance (i.e., the distance from the mirror surface to the focal point). Typically, based on the design wavelength and target focal spot size, appropriate object and image distances are selected following an approximate spherical focusing formula.

In some embodiments, the first focusing lens 120 is a concave mirror and has a first focusing point P1 on its concave surface. The second focusing lens 122 is also a concave mirror and has a second focusing point P2 on its concave surface. The distance between the X-ray source 10 and the first focusing point P1 is a first distance L1, the distance between the first focusing point P1 and the second focusing point P2 is a second distance L2, and the distance between the second focusing point P2 and the predetermined position P0 is a third distance L3. In addition, the first distance L1 is greater than the second distance L2, and the third distance L3 is greater than the first distance L1. Preferably, the first distance L1 is within a length range of 1 to 1.4 times the second distance L2, and the third distance L3 is within a length range of 1.45 to 2 times the second distance L2.

The divergence angle control element 14 is disposed between the optical mirror assembly 12 and the predetermined position P0, the divergence angle control element 14 has a first portion 140 and a second portion 142 that are spaced apart from each other by a predetermined distance Da. At least a portion of focused incident X-ray beam Lx1 passes between the first portion 140 and the second portion 142.

The first portion 140 and the second portion 142 are arranged along a direction D1 and spaced apart by the predetermined distance Da, and the direction D1 is perpendicular to an incident direction Dx of the focused incident X-ray beam Lx1.

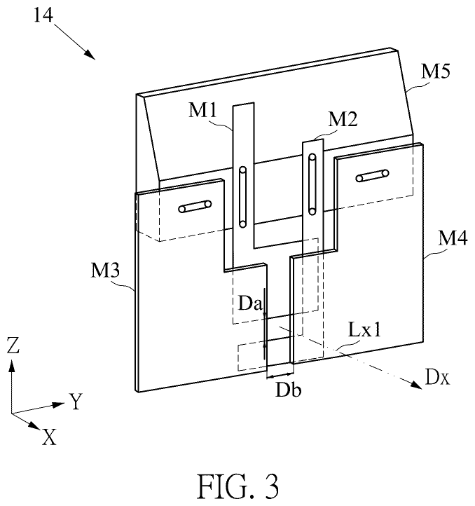

Referring to FIG. 3, which is a schematic view of a divergence angle control element according to one embodiment of the present disclosure. As shown in FIG. 3, the divergence angle control element 14 includes a first plate M1, a second plate M2, a third plate M3, and a fourth plate M4. The first plate M1, the second plate M2, the third plate M3, and the fourth plate M4 are L-shaped plates stacked together. They can be movably mounted on a base M5, for example, by means of slide grooves and screws. Each of the L-shaped plates has its long end extending along the Z-axis and its short end extending along the Y-axis.

As shown in FIG. 3, the short ends of the first plate M1 and the second plate M2 are arranged along the Z-axis and are spaced apart by the predetermined distance Da. Direction of the Z-axis is perpendicular to the incident direction Dx (i.e., along the X direction) of the focused incident X-ray beam Lx1. The short ends of the third plate M3 and the fourth plate M4 are arranged along the Y-axis and are spaced apart by a predetermined distance Db. The short end of the first plate M1 has a first tip portion S1 that is included by the aforementioned first portion 140, and the short end of the second plate M2 has a second tip portion S2 that is included by the aforementioned second portion 142, and the first tip portion S1 and the second tip portion S2 are opposite to each other. In order to reduce scattering effect and other noise of the focused incident X-ray beam Lx1, the first tip portion S1 and the second tip portion S2 have a roughness range from 0 nm to 10 nm. The roughness is, for example, an arithmetic mean roughness Ra, a ten-point average roughness Rz or a maximum height Ry.

Further referring to FIG. 1, the divergence angle control element 14 (e.g., the first plate M1, the second plate M2, the third plate M3, and the fourth plate M4) can be driven by the first divergence angle control mechanism 15 to cause relative movement between the first portion 140 and the second portion 142 (e.g., the first tip portion S1 and the second tip portion S2), thereby changing the predetermined distance Da, which in turn changes the divergence angle A1 of the measurement X-ray beam Lx2 generated by the test object being irradiated by the focused incident X-ray beam Lx1. The first divergence angle control mechanism 15 can be, for example, a stepping motor.

Furthermore, alternatively, the X-ray measurement system 1 can further include a second divergence angle control mechanism 17 configured to manually drive the divergence angle control element 14 (e.g., the first plate M1, the second plate M2, the third plate M3, and the fourth plate M4), such that the first portion 140 and the second portion 142 (e.g., the first tip portion S1 and the second tip portion S2) move relative to each other to change the predetermined distance Da, which in turn changes the divergence angle A1 of the measurement X-ray beam Lx2 generated by the test object being irradiated by the focused incident X-ray beam Lx1. The second divergence angle control mechanism 17 can be, for example, a sliding rail.

The two-dimensional detector 16 is configured to receive the measurement X-ray beam Lx2 generated from the test object that is irradiated by the focused incident X-ray beam Lx1, and the measurement X-ray beam Lx2 having the divergence angle A1 that varies with the predetermined distance.

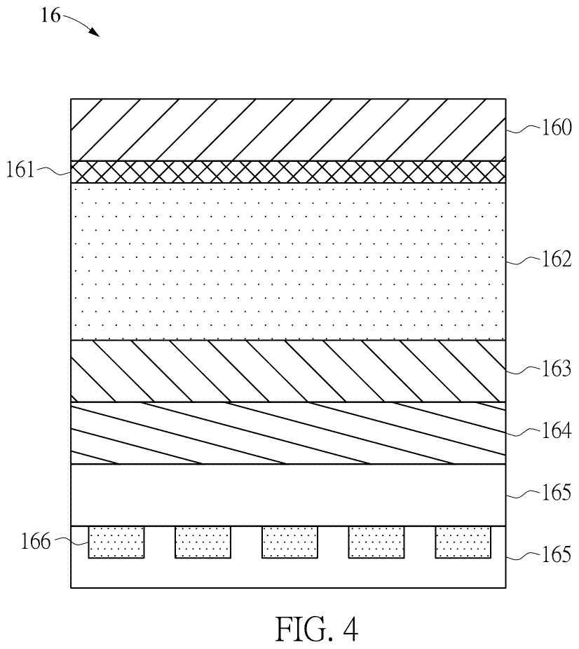

Referring to FIG. 4, FIG. 4 is a schematic exploded view of a two-dimensional detector according to one embodiment of the present disclosure. The two-dimensional detector 16 can, for example, be a back-illuminated type two-dimensional detector. The two-dimensional detector 16 includes a negative bias electrode layer 160, an electron blocking layer 161, an active layer 162, a first-type semiconductor layer 163, a second-type semiconductor layer 164, an insulating layer 165, and a polysilicon electrode layer 166. The first-type semiconductor layer 163 and the second-type semiconductor layer 164 are respectively a P-type silicon layer and an N-type silicon layer to form a photodiode. The negative bias electrode layer 160 can be made of a conductive metal, such as Pt, Cr, or Au, or other suitable electrode materials.

The focused incident X-ray beam Lx1 passes through the active layer 162 and is converted into an electronic signal through photoelectric effect or Compton scattering, and the surface negative bias electrode layer 160 on the surface and the electron blocking layer 161 are configured to prevent electrons from returning to the electrode. After the electrons are transferred to the P-type silicon layer, a depletion region is formed between the P-type silicon layer and the N-type silicon layer due to the difference in electron carrier concentration, and the electrons then move to the polysilicon electrode layer 166 through diffusion movement. The number of electrodes of the polysilicon electrode layers 166 can be one or more. When there are multiple, they can be arranged in a two-dimensional array form. The insulating layers 165 are disposed above and below the polysilicon electrode layer 166. The insulating layer 165 is configured to protect the polysilicon electrode layer 166 and to prevent leakage current from the polysilicon electrode layer 166. The insulating layer 165 can, for example, be made of silicon dioxide.

The following further explains energy resolution of the aforementioned two-dimensional detector 16. When calculating the energy resolution, three main noise sources need to be considered: electron generation statistical variation (Fano noise), readout noise, and photon statistical noise (shot noise). The energy resolution can be calculated using the following formula:

$$Δ E = 2.35 \times \sqrt{F \times E \times ω + {N}_{r}^{2} + {N}_{s}^{2}} .$$

Wherein, ΔE is the energy resolution (FWHM, unit: eV), F is the Fano factor, which is approximately 0.115 for silicon. E is the X-ray energy (unit: eV), ω is the energy required to generate an electron-hole pair (3.65 eV for silicon), Nᵣ is the readout noise (unit: electrons, e⁻), and Nₛ is the photon statistical noise, which can be calculated as

$${N}_{s} = \sqrt{\frac{E}{ω}} .$$

Taking 92 e V X-rays as an example, ΔE=2.35×99.884≈2.35×9.994-23.48 eV, which is very close to the experimental result (23.66 eV), verifying the accuracy of the theoretical model.

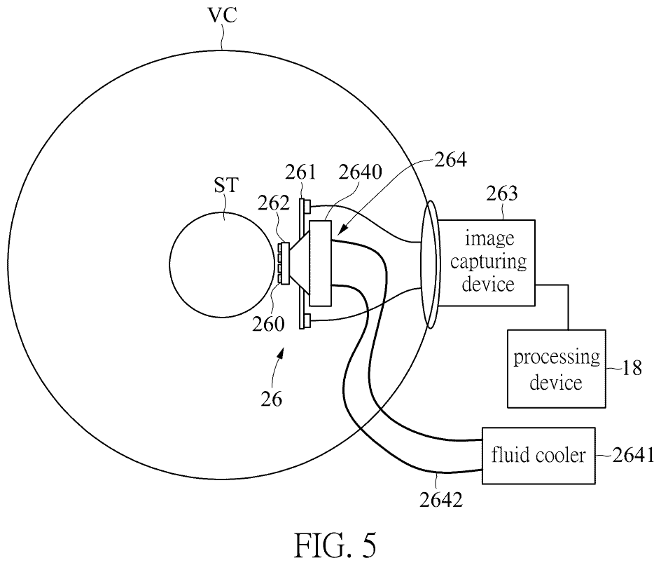

Reference is made to FIG. 5, which is a schematic architecture view of another two-dimensional detector according to one embodiment of the present disclosure. As shown in FIG. 5, the two-dimensional detector 26 includes a plurality of superconducting detecting elements 260. The superconducting detecting elements 260 are disposed on a circuit substrate 261 and are arranged to form a detector array chip 262, and each of the superconducting detecting elements 260 is a superconducting nanowire detector that has a superconducting nanowire layer (e.g., a niobium nitride (NbN) nanowire). The superconducting nanowires on the superconducting nanowire layer are configured to form a continuous meandering nanowire pattern on the sensing surface, which is configured to detect single photons.

The detector array chip 262 is configured to receive the measurement X-ray beam Lx2, an image capturing device 263 is electrically connected to the detector array chip 262 through the circuit substrate 261, and the detector array chip 262 needs to be independent from the main body of the image capturing device 263 and is configured with a cooling design that can reduce noise, such as a fluid cooling device 264. The image capturing device 263 can, for example, be a digital camera, which is electrically connected to the processing device 18. The processing device 18 can include a low-noise front-end amplifier, a high-speed data converter, and a data processing unit for reading the images captured by the image capturing device 263.

As shown in FIG. 5, the fluid cooling device 264 includes a cooling metal member 2640 and a fluid cooler 2641. The cooling metal member 2641 is in contact with the circuit substrate 261 and is connected to the fluid cooler 2641 through at least one fluid line 2642.

In some embodiments, the fluid cooling device 264 is configured to absorb heat from the circuit substrate 261, and the cooling metal member 2640 can be made of a metal (e.g., copper) with good thermal conductivity. One surface of the fluid cooling device 264 is in close contact with the circuit substrate 261, thereby effectively transferring the heat generated by the circuit substrate 261 during operation into the cooling metal member 2640. The cooling metal member 2640 is provided with an internal channel and is connected to the fluid cooler 2641 through a fluid line 2642, such that cooling fluid can circulate through the internal channel of the cooling metal member 2640. By continuously supplying cooling fluid at a lower temperature through the fluid cooler 2641, the cooling fluid flowing inside the cooling metal member 2640 can carry away the absorbed heat, thereby reducing the overall temperature of the cooling metal member 2640 and the circuit substrate 261. This allows the detector array chip 262 to operate at an ultra-low temperature (e.g., 2.5 K). At such ultra-low temperatures, the superconducting nanowires exhibit excellent superconductivity, which can significantly reduce electronic noise and enhance detection efficiency. In addition, the detector array chip 262 can have multi-channel detection characteristics, and each of the superconducting detecting elements 260 possesses high temporal and spatial resolution. This will significantly enhance the overall detection capability of the system, supporting higher-precision X-ray imaging and measurement, thereby providing strong technical support for semiconductor manufacturing processes.

During the measurement process, the multi-axis sample stage ST, the circuit substrate 261, the detector array chip 262, and the cooling metal member 2640 can be disposed inside a vacuum cavity CV to ensure that the interior of the cavity is maintained at an ultra-low temperature and to prevent the cooling efficiency from being affected by the temperature of external gases.

Furthermore, when the focused incident X-ray beam Lx1 irradiates the test object SP, the measurement X-ray beams Lx2 are generated due to reflection, diffraction, scattering, or transmission, depending on the incidence angle. By placing the two-dimensional detector 16 at an appropriate position, the two-dimensional detector 16 can be used to receive the measurement X-ray beams Lx2 produced by reflection, diffraction, scattering, or transmission.

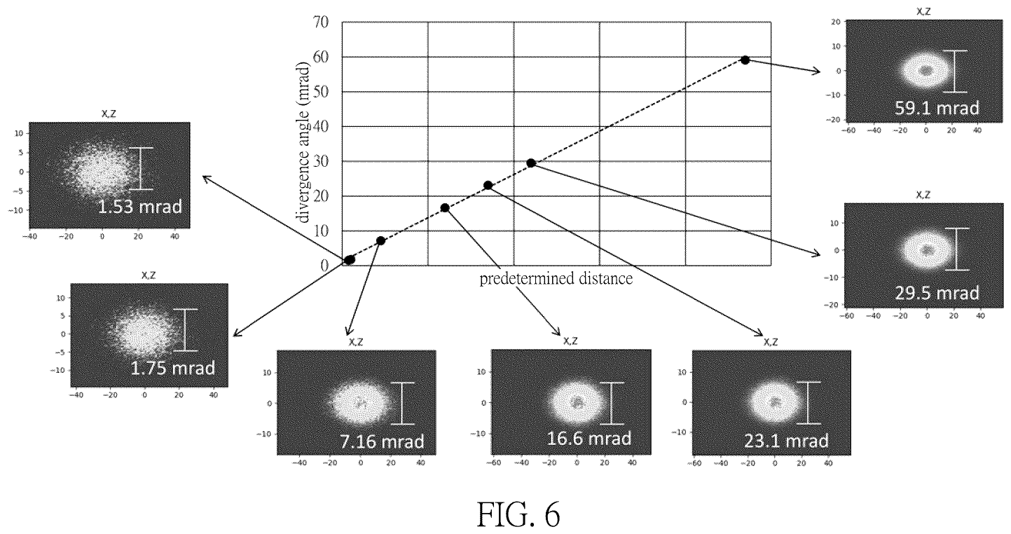

Reference is made to FIG. 6, which is a curve diagram of a divergence angle and a predetermined distance according to one embodiment of the present disclosure. As shown in FIG. 6, as the predetermined distance Da increases, the divergence angle A1 of the measurement X-ray beam Lx2 also increases accordingly, whereby the divergence angle A1 can be freely adjusted according to requirements.

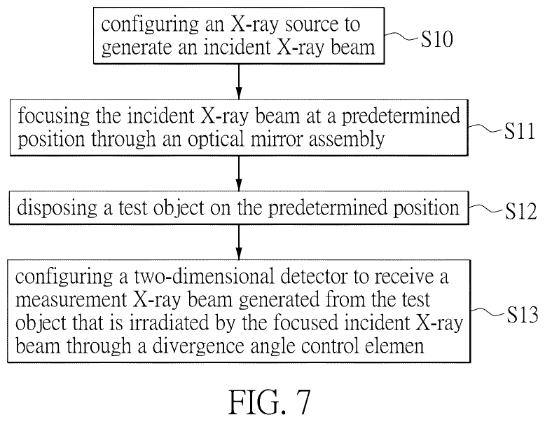

Reference is made to FIG. 7, which is a flowchart of an X-ray measurement method according to one embodiment of the present disclosure. As shown in FIG. 7, an embodiment of the present disclosure provides an X-ray measurement method, which includes at least the following steps:

Step S10: configuring an X-ray source to generate an incident X-ray beam.

Step S11: focusing the incident X-ray beam at a predetermined position through an optical mirror assembly.

Step S12: disposing a test object on the predetermined position.

Step S13: configuring a two-dimensional detector to receive a measurement X-ray beam generated from the test object that is irradiated by the focused incident X-ray beam through a divergence angle control element.

In this step, the predetermined distance Da between the first portion 140 and the second portion 142 of the divergence angle control element 14 can be adjusted according to the required divergence angle. Therefore, when at least a portion of the focused incident X-ray beam Lx1 passes through between the first portion 140 and the second portion 142 and irradiates the test object SP, the resulting measurement X-ray beam Lx2 has a divergence angle A1 corresponding to the predetermined distance Da (as shown in FIG. 6).

In addition, the two-dimensional detector 16 can be connected to a moving mechanism (not shown in the drawings). Therefore, in step S13, the moving mechanism can be controlled by the processing device 18 to rotate the two-dimensional detector 16 around the test object SP and receive measurement X-ray beams Lx2 from multiple positions. Finally, the processing device 18 combines captured two-dimensional images to generate a corresponding X-ray spectral information. Furthermore, the processing device 18 can be configured to perform a fitting analysis procedure according to the X-ray spectral information to obtain one or more structural parameters of a test sample as an analysis result. The structural parameters include one or more of thickness, roughness, density, critical dimension, line edge roughness, refractive index, and extinction coefficient.

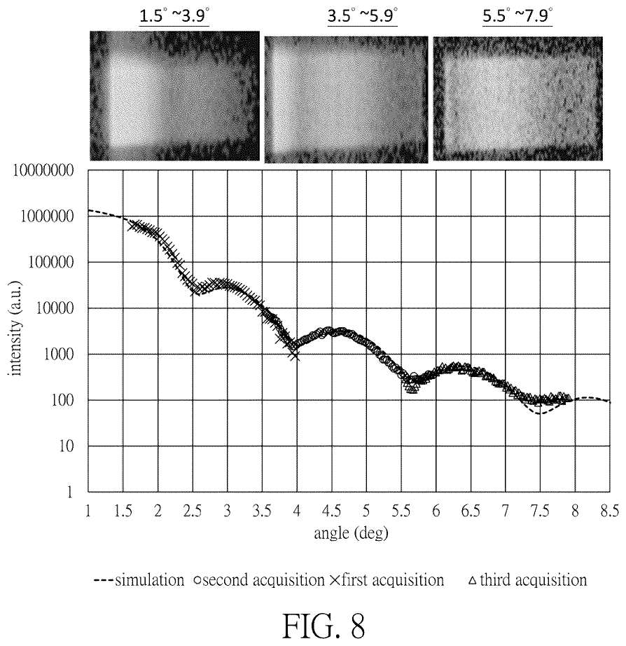

Reference is made to FIG. 8, which is actual measurement results and a simulation curve diagram of the X-ray measurement system according to one embodiment of the present disclosure. In the present experiment, X-ray reflection critical dimension (XRCD) measurement was performed on a test object SP with a single-layer HfO2 thin film deposited on a silicon substrate. The incident X-ray beam has an angle of 1.5° and a divergence angle of 2.4° (equivalent to 41.9 mrad), and after being focused and irradiated onto the test object SP, the resulting measurement X-ray beam Lx2 is received by the two-dimensional detector 16. The captured images, as shown above the curve diagram in FIG. 8, cover a total angular range from 1.5° to 7.9° through three separate single-image acquisitions (each with an exposure time of 10 seconds, at angles of 1.5° to 3.9°, 3.5° to 5.9°, and 5.5° to 7.9°, respectively). The combined reflection pattern obtained after merging closely matches the simulation results, demonstrating good measurement accuracy. The present design, combining a beam with adjustable divergence characteristics and a two-dimensional detector, significantly enhances data acquisition efficiency (throughput). This design not only shortens the overall measurement time but also eliminates the need for mechanical scanning, making it suitable for applications requiring high resolution and high-efficiency reflection inspection.

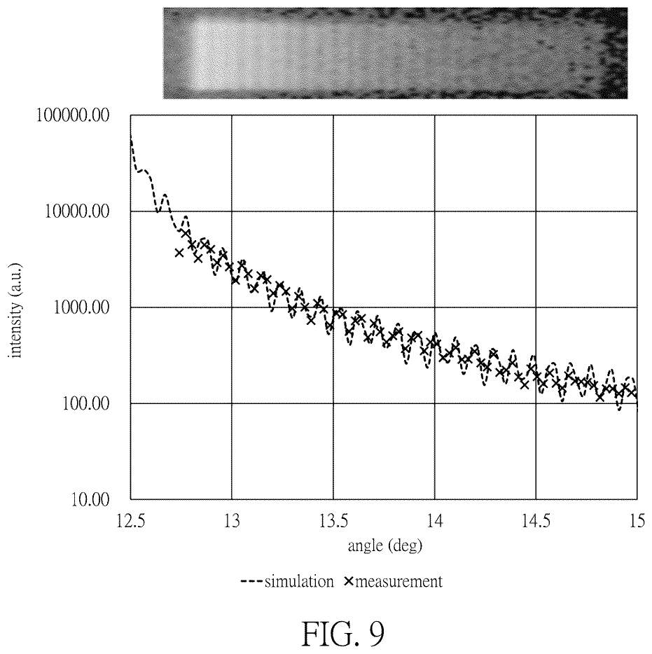

Reference is made to FIG. 9, which is another actual measurement results and the simulation curve diagram of the X-ray measurement system according to one embodiment of the present disclosure. In the present experiment, XRCD measurement is performed on a semiconductor stacked device with 130 layers. A focused beam with an incidence angle of 12.74° and a divergence angle of 2.26° (equivalent to 39.4 mrad) irradiates the sample, and the reflected signals are captured by the two-dimensional detector 16. The captured image is shown above the curve diagram in FIG. 9. By acquiring a single image (exposure time of 10 seconds), the angular range from 12.74° to 15° can be covered, successfully obtaining the zero-order signal, which is highly consistent with the simulation results. The present measurement method fully demonstrates the high-efficiency advantage of data acquisition, enabling the capture of high-angle resolution data in a very short time and eliminating the time-consuming steps of traditional mechanical scanning. It is especially suitable for rapid characterization and analysis of multilayer nanoscale structures.

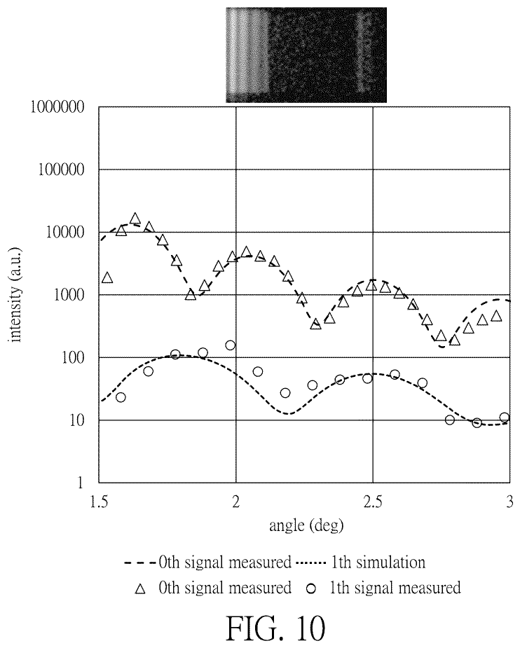

Reference is made to FIG. 10, which is another actual measurement results and the simulation curve diagram of the X-ray measurement system according to one embodiment of the present disclosure. In the present experiment, reflection spectrum measurement is performed on a semiconductor stacked device with a one-dimensional grating structure. The sample has structural features with a thickness of 50 nm and a period of 139 nm. The incident X-ray is set at 1.5°, and a focused beam with a divergence angle of 1.32° (23.1 mrad) is used to irradiate the sample, with data acquired by the two-dimensional detector 16. By a single exposure (one-shot), an effective dynamic Q (angular) range of approximately 2.96° can be covered, enabling efficient acquisition of the X-ray reflection spectrum signal. The present configuration greatly improves measurement throughput, enabling high-resolution reflection spectrum scans to be completed in a short time without the need for mechanical angle scanning, making it suitable for applications requiring high-efficiency, non-destructive structural analysis and process monitoring.

### Beneficial Effects of the Embodiments

One of the advantageous effects of the present disclosure is that the X-ray measurement system and X-ray measurement method provided by the present disclosure with adjustable beam divergence angle and two-dimensional detector have multiple key advantages. First, by using a focused X-ray beam with a divergence angle, broad coverage of the dynamic Q-space can be achieved in a single exposure, effectively enhancing the measurement range and resolution. Coupled with a two-dimensional detector, this not only simplifies the need for mechanical movement and reduces mechanical errors, but also enables rapid acquisition of reflection signals from multiple angles and directions, significantly improving overall measurement throughput and reproducibility. In addition, the present system possesses excellent energy resolution, making it suitable for analyzing specific energies in multi-wavelength systems. The present system can also perform precise measurements on specific regions of interest (ROI), further enhancing the signal-to-noise ratio and the accuracy of the results.

Furthermore, the X-ray measurement system and the X-ray measurement method provided by the present disclosure are particularly suitable for in situ measurement applications, enabling real-time observation of the structural evolution of materials under varying external conditions. Whether the materials consist of single-layer, multilayer, or three-dimensional periodically arranged nanostructures (including in the Qx, Qy, and Qz directions), the system can effectively resolve Kiessig fringes generated by periodic structures. In this way, highly sensitive and high-resolution structural information can be provided, offering a powerful tool for the non-destructive characterization of nanomaterials, thin film stacks, and functional devices.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An X-ray measurement system, comprising:
an X-ray source configured to generate an incident X-ray beam;
an optical mirror assembly configured to focus the incident X-ray beam at a predetermined position;
a divergence angle control element disposed between the optical mirror assembly and the predetermined position, the divergence angle control element having a first portion and a second portion that are spaced apart from each other by a predetermined distance, wherein at least a portion of focused incident X-ray beam passes between the first portion and the second portion; and
a two-dimensional detector configured to receive a measurement X-ray beam generated from a test object that is irradiated by the focused incident X-ray beam, and the measurement X-ray beam having a divergence angle that varies with the predetermined distance.

2. The X-ray measurement system according to claim 1, wherein the optical mirror assembly includes a first focusing lens and a second focusing lens, and wherein the first focusing lens and the second focusing lens are respectively configured to focus the incident X-ray beam in a first direction and a second direction, and the first direction is perpendicular to the second direction.

3. The X-ray measurement system according to claim 2, wherein the first portion and the second portion are arranged along a third direction and are spaced apart by the predetermined distance, and the third direction is perpendicular to an incident direction of the focused incident X-ray beam.

4. The X-ray measurement system according to claim 3, wherein the first portion includes a first tip portion, the second portion includes a second tip portion, and the first tip portion and the second tip portion are opposite to each other.

5. The X-ray measurement system according to claim 4, wherein the first tip portion and the second tip portion have a roughness within a range from 0 nm to 10 nm.

6. The X-ray measurement system according to claim 3, further comprising a first divergence angle control mechanism configured to drive the divergence angle control element such that the first portion and the second portion move relative to each other to change the predetermined distance.

7. The X-ray measurement system according to claim 3, further comprising a second divergence angle control mechanism configured to manually drive the divergence angle control element such that the first portion and the second portion move relative to each other to change the predetermined distance.

8. The X-ray measurement system according to claim 2, wherein the first focusing lens has a first focusing point, and the second focusing lens has a second focusing point; wherein the distance between the X-ray source and the first focusing point is a first distance, the distance between the first focusing point and the second focusing point is a second distance, and the distance between the second focusing point and the predetermined position is a third distance; and wherein the first distance is greater than the second distance, and the third distance is greater than the first distance.

9. The X-ray measurement system according to claim 1, wherein the two-dimensional detector includes a negative bias electrode layer, an electron blocking layer, an active layer, a first-type semiconductor layer, a second-type semiconductor layer, an insulating layer, and a polysilicon electrode layer.

10. The X-ray measurement system according to claim 1, wherein the two-dimensional detector includes:
a plurality of superconducting detecting elements disposed on a circuit substrate and arranged to form a detector array chip, wherein each of the superconducting detecting elements includes a superconducting nanowire layer;
an image capturing device electrically connected to the detector array chip through the circuit substrate; and
a fluid cooling device including a cooling metal member and a fluid cooler, wherein the cooling metal member is in contact with the circuit substrate and is connected to the fluid cooler through at least one fluid line.

11. An X-ray measurement method, comprising:
configuring an X-ray source to generate an incident X-ray beam;
focusing the incident X-ray beam at a predetermined position through an optical mirror assembly;
disposing a test object on the predetermined position; and
configuring a two-dimensional detector to receive a measurement X-ray beam generated from the test object that is irradiated by the focused incident X-ray beam through a divergence angle control element, wherein the divergence angle control element is disposed between the optical mirror assembly and the predetermined position, the divergence angle control element has a first portion and a second portion that are spaced apart from each other by a predetermined distance, and wherein at least a portion of focused incident X-ray beam passes between the first portion and the second portion, and the measurement X-ray beam has a divergence angle that varies with the predetermined distance.

12. The X-ray measurement method according to claim 11, wherein the optical mirror assembly includes a first focusing lens and a second focusing lens, and wherein the first focusing lens and the second focusing lens are respectively configured to focus the incident X-ray beam in a first direction and a second direction, and the first direction is perpendicular to the second direction.

13. The X-ray measurement method according to claim 12, wherein the first portion and the second portion are arranged along a third direction and are spaced apart by the predetermined distance, and the third direction is perpendicular to an incident direction of the focused incident X-ray beam.

14. The X-ray measurement method according to claim 13, wherein the first portion includes a first tip portion, the second portion includes a second tip portion, and the first tip portion and the second tip portion are opposite to each other.

15. The X-ray measurement method according to claim 14, wherein the first tip portion and the second tip portion have a roughness within a range of 0 nm to 10 nm.

16. The X-ray measurement method according to claim 13, further comprising following processes:
configuring a first divergence angle control mechanism to drive the divergence angle control element such that the first portion and the second portion move relative to each other to change the predetermined distance.

17. The X-ray measurement method according to claim 13, further comprising following processes:
configuring a second divergence angle control mechanism to manually drive the divergence angle control element such that the first portion and the second portion move relative to each other to change the predetermined distance.

18. The X-ray measurement method according to claim 12, wherein the first focusing lens has a first focusing point, and the second focusing lens has a second focusing point; wherein the distance between the X-ray source and the first focusing point is a first distance, the distance between the first focusing point and the second focusing point is a second distance, and the distance between the second focusing point and the predetermined position is a third distance; and wherein the first distance is greater than the second distance, and the third distance is greater than the first distance.

19. The X-ray measurement method according to claim 11, wherein the two-dimensional detector includes a negative bias electrode layer, an electron blocking layer, an active layer, a first-type semiconductor layer, a second-type semiconductor layer, an insulating layer, and a polysilicon electrode layer.

20. The X-ray measurement method according to claim 11, wherein the two-dimensional detector includes:
a plurality of superconducting detecting elements disposed on a circuit substrate and arranged to form a detector array chip, wherein each of the superconducting detecting elements includes a superconducting nanowire layer;
an image capturing device electrically connected to the detector array chip through the circuit substrate; and
a fluid cooling device including a cooling metal member and a fluid cooler, wherein the cooling metal member is in contact with the circuit substrate and is connected to the fluid cooler through at least one fluid line.
